(19) United States
(12) Patent Application Publication
(10) Pub. No.: US 2009/0261692 A1
(43) Pub. Date: Oct. 22, 2009

(54) Motor

(76) Inventor: Alex Horng, Kaohsiung (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/421,766

(22) Filed: Apr. 10, 2009

Related U.S. Application Data
(63) Continuation-in-part of application No. 12/081,422, filed on Apr. 16, 2008.

(51) Int. Cl. H02K 5/167

(52) U.S. Cl. 310/425

(57) ABSTRACT

A motor includes a base, a stator and a bearing both mounted to the base, a rotor and a retaining ring. The rotor includes a shaft having an annular groove formed in an outer periphery thereof to form a neck with a first outer diameter. The shaft includes an obstructing portion forming an end edge of the annular groove and having a second outer diameter larger than the first outer diameter. The retaining ring is partially received in the annular groove. The retaining ring includes a combining section for positioning itself and a retaining section delimiting a through hole with a diameter larger and smaller than the first and second outer diameters respectively to form a gap between the through hole and neck. Consequently, noise by friction of the retaining ring against the shaft and departure of the rotor from the base are avoided with unlimited assembly of the motor.

### CROSS REFERENCE TO RELATED APPLICATION

This is a continuation-in-part application of U.S. patent application Ser. No. 12/081,422 filed on Apr. 16, 2008.

### BACKGROUND OF THE INVENTION

1. Field of the Invention

The present invention relates to a motor and, more particularly, to a motor that can prevent movement of a retaining ring in a shaft tube and avoid noise produced by friction of the retaining ring against other components in the shaft tube.

2. Description of the Related Art

FIG. 1 shows a conventional motor 9 including a stator 91, a rotor 92 and a base 93 where the stator 91 and the rotor 92 are mounted.

A shaft tube 931 is fixed to the center of the base 93 and a bearing 932 having an axial hole (not labeled) is received in the shaft tube 931.

The rotor 92 includes a hub 921, a shaft 922 with one end fixed to the hub 921, and an annular groove 923 formed in an outer periphery of and close to the other end of the shaft 922 to form a neck of the shaft 922. In assembly, after an oil seal 94 and a gasket 95 are mounted around the shaft 922 and close to the hub 921, the end of the shaft 922, to which the annular groove 923 is close, can pass through the axial hole of the bearing 932. And then a retaining ring 99 firmly attaches to the neck of the shaft 922 after another oil seal 96, a washer 97 and another gasket 98 are mounted around the shaft 922 and close to the annular groove 923. Finally, an end cap 90 is mounted to and thus seals the bottom of the shaft tube 931.

Nevertheless, referring to FIG. 2, said conventional motor 9 has several drawbacks in use as the following.

First, since a diameter of the neck is larger than an inner diameter of the retaining ring 99 for the retaining ring 99 to surround the neck of the shaft 922 by gap-less close-fit, deformation of the retaining ring 99 owing to a forcible insertion of the shaft 922 is easily caused. Therefore, because of the deformation of the retaining ring 99, a possibility of disengagement of the rotor 92 from the base 93 during packing, conveyance or utilization of the conventional motor 9 is raised.

Second, the retaining ring 99 is liable to hit the gasket 98 because the retaining ring 99 turns with the shaft 922 synchronously, and the retaining ring 99 with deformation may also rub against the shaft 922 due to undesired gaps existing along with the said deformation and between the shaft 922 and the retaining ring 99. Thus, revolving instability of the rotor 92 is caused and friction-induced noise is arisen.

Third, the retaining ring 99 is fastened to the neck of the shaft 922 via the open bottom of the shaft tube 931 after the shaft 922 passes through the axial hole of the bearing 932, and then end cap 90 fully seals the bottom of the shaft tube 931 to finish the assembly of the motor 9. And the above description shows that combining the shaft 922 with the bearing 932 and the retaining ring 99 can not be done in one step. As a result, inconvenience of assembling the motor 9 is caused.

### SUMMARY OF THE INVENTION

The primary objective of the present invention is to provide a motor that solves the problems of the conventional motor resulting from synchronous rotation of a shaft and a retaining ring, and avoids friction-induced noise.

The secondary objective of this invention is to provide the motor with an assembly thereof being convenient.

A motor according to the preferred teachings of the present invention includes a base, a stator, a bearing, a rotor and a retaining ring. The base includes a shaft tube. The stator is mounted to the base. The bearing is received in the shaft tube and includes a central hole. The rotor includes a shaft rotatably extending through the central hole of the bearing. An annular groove is formed in an outer periphery of the shaft to form a neck with a first outer diameter. The shaft includes an obstructing portion that forms an end edge of the annular groove and has a second outer diameter larger than the first outer diameter. The retaining ring is received in the shaft tube and partially received in the annular groove. The retaining ring includes a combining section positioned at an end face of the bearing and a retaining section with a blocking edge delimiting a through hole. The blocking edge radially extends towards a central line of the through hole to be within a longitudinal extending area of the central hole of the bearing. A diameter of the through hole is larger than the first outer diameter to form a gap between a periphery of the through hole and the neck. The diameter of the through hole is smaller than the second outer diameter to retain the obstructing portion of the shaft of the rotor. Accordingly, friction-induced noise resulted from the retaining ring and the shaft rubbing against each other is greatly suppressed, departure of the rotor from the base is avoided and the convenience in assembly of the motor is improved.

In a most preferred form, the rotor further includes a hub and one end of the shaft couples to the hub, the bearing includes a first end face facing the hub and a second end face, the annular groove is close to another end of the shaft as a free end that rotatably extends through the central hole of the bearing, the combining section includes two end faces those are a first positioning face facing the hub and a second positioning face, and the first positioning face abuts on and is positioned at the second end face of the bearing. Accordingly, the retaining ring is prevented from axially moving to enhance convenience of assembling and provide reliable combination.

In a most preferred form, the shaft tube includes a first end and a second end, with an end cap being mounted to the second end, with the second positioning face of the combining section of the retaining ring abutting on and being positioned at the end cap to sandwich the retaining ring between the bearing and the end cap. Accordingly, the retaining ring is stably positioned.

In a most preferred form, the rotor further includes a hub and one end of the shaft couples to the hub, with the bearing including a first end face facing the hub and a second end face, with the annular groove being close to the hub, with the combining section including two end faces those are a first positioning face facing the hub and a second positioning face, with the first positioning face abutting on and being positioned at the first end face of the bearing. Accordingly, the through hole of the retaining ring can be easily aligned with the central hole of the bearing to simplify assembly of the motor.

In a most preferred form, a positioning flange is mounted on the first positioning face of the combining section of the retaining ring, with the positioning flange being fixed to an inner surface of the shaft tube. Accordingly, the retaining ring is assuredly fixed to the inner surface of the shaft tube without disengagement from the shaft tube, so as to ensure that departure of the rotor is avoided and other components, such as the bearing, are also further prevented from disengaging from the shaft tube.

In a most preferred form, the combining section of the retaining ring has an outer lateral edge radially abutting on and positioned at an inner surface of the shaft tube. Accordingly, radial movement of the retaining ring is avoided to enhance convenience of assembling and provide reliable combination.

In a most preferred form, an end of the obstructing portion, which forms the end edge of the annular groove, is an annular plane parallel to the retaining section of the retaining ring. Accordingly, a great difficulty in pulling the shaft out of the retaining ring is provided to achieve reliable departure-proof effect on the rotor.

In a most preferred form, a diameter of a part of the central hole of the bearing is enlarged to form an oil-storing compartment inside the bearing, with the blocking edge extending inwards to define the through hole of the retaining ring smaller than the central hole of the bearing except for the oil-storing compartment. Accordingly, lubricant can be received in the oil-storing compartment to provide smooth rotation of the rotor and prolong life of the motor.

In a most preferred form, the gap has a width smaller than or equal to 0.67 mm, with the width being a distance from the periphery of the through hole to a bottom surface of the neck. Accordingly, the retaining ring is prevented from revolving with the shaft to reduce noise effectively.

Further scope of the applicability of the present invention will become apparent from the detailed description given hereinafter. However, it should be understood that the detailed description and specific examples, while indicating preferable embodiments of the invention, are given by way of illustration only, since various will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a cross sectional view illustrating a conventional motor;

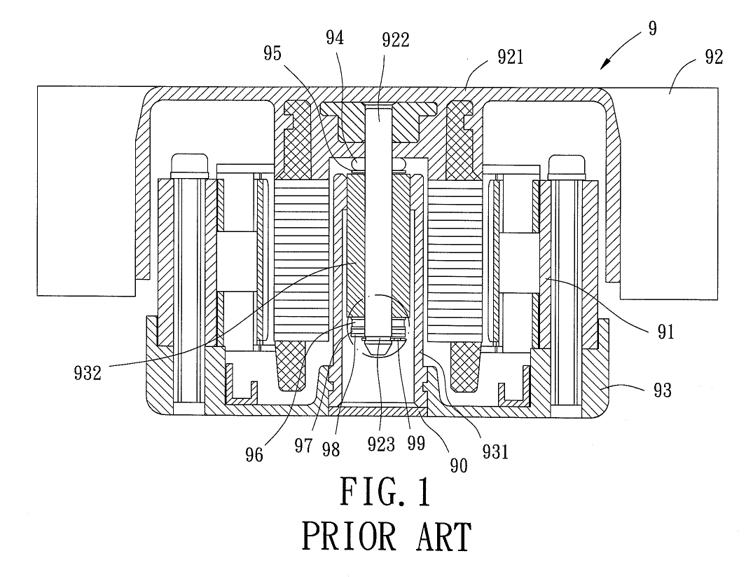

FIG. 2 is a partial and enlarged view illustrating the conventional motor of FIG. 1;

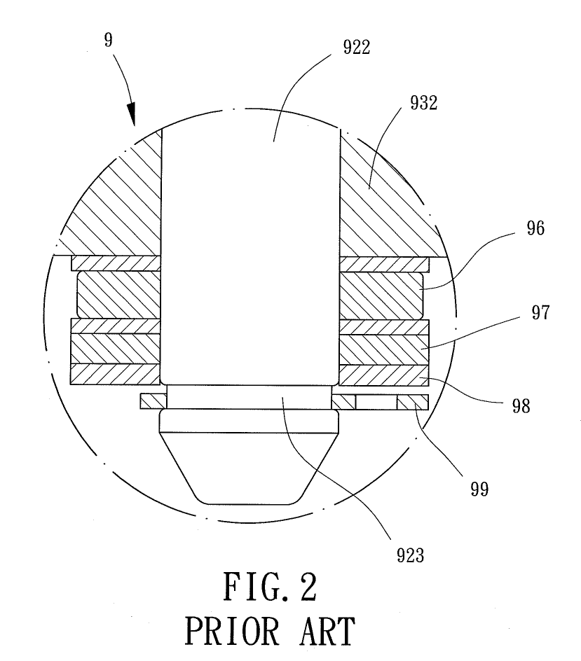

FIG. 3 is a cross sectional view illustrating a motor in accordance with a first embodiment of the present invention;

FIG. 4 is a partial and enlarged view illustrating the motor of FIG. 3;

FIG. 5 is a cross sectional view illustrating a motor in accordance with a second embodiment of the present invention; and

FIG. 6 is a partial and enlarged view illustrating the motor of FIG. 5.

All figures are drawn for ease of explanation of the basic teachings of the present invention only; the extensions of the figures with respect to number, position, relationship, and dimensions of the parts to form the preferred embodiment will be explained or will be within the skill of the art after the following teachings of the present invention have been read and understood. Further, the exact dimensions and dimensional proportions to conform to specific force, weight, strength, and similar requirements will likewise be within the skill of the art after the following teachings of the present invention have been read and understood.

Where used in the various figures of the drawings, the same numerals designate the same or similar parts. Furthermore, when the terms “first”, “second”, “inner”, “outer”, “end”, “portion”, “section”, “bottom”, “longitudinal”, “radial”, “lateral”, “annular”, “inward”, and similar terms are used herein, it should be understood that these terms have reference only to the structure shown in the drawings as it would appear to a person viewing the drawings and are utilized only to facilitate describing the invention.

### DETAILED DESCRIPTION OF THE INVENTION

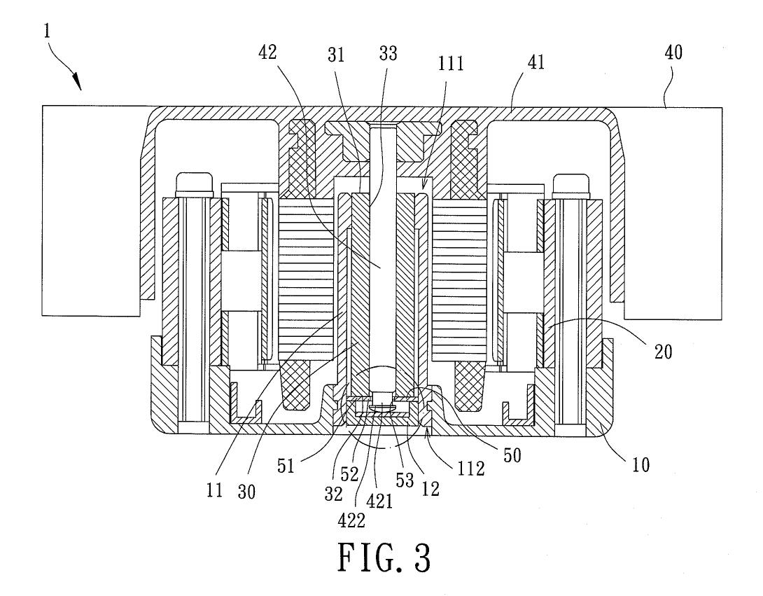

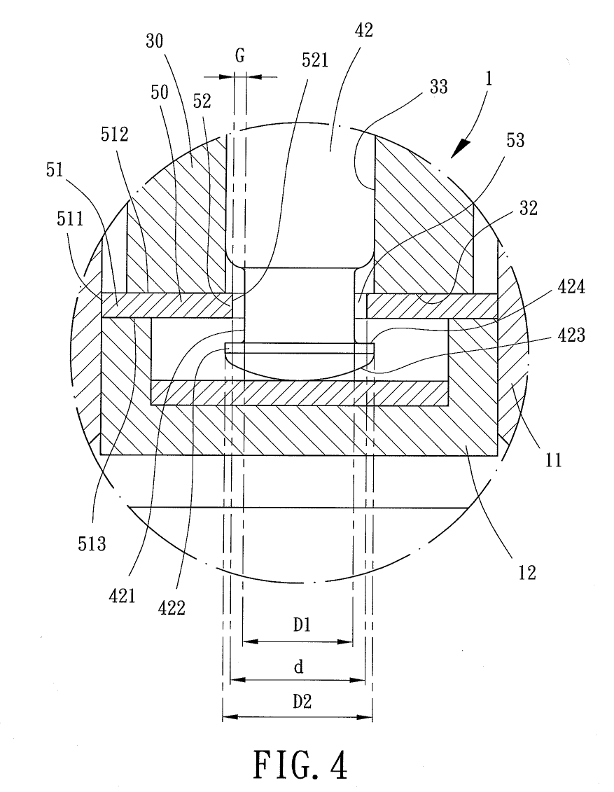

A motor designated “1” of a first embodiment according to the preferred teachings of the present invention is shown in FIGS. 3 and 4 of the drawings. According to the first embodiment form shown, the motor 1 includes a base 10, a stator 20, a bearing 30, a rotor 40 and a retaining ring 50.

The base 10 has a shaft tube 11 with a first end 111 that is open and a second end 112 that is closed, wherein the shaft tube 11 can be selected from a combination of a hollow tube with two open ends and an end cap 12 mounted to one end of the hollow tube to form the sealed second end 112. Alternatively, the shaft tube 11 can form the closed second end 112 alone and integrally.

The stator 20 of the first embodiment according to the preferred teachings of the present invention is mounted to the base 10 to drive the rotor 40 to rotate.

The bearing 30 has a first end face 31, a second end face 32 and a central hole 33 connecting with the first end face 31 and the second end face 32. And the bearing 30 is received in the shaft tube 11 of the base 10, with the first end face 31 and the second end face 32 being adjacent to the open first end 111 and the closed second end 112 respectively.

The rotor 40 has a hub 41 and a shaft 42, with the hub 41 covering and surrounding the stator 20 to form an air gap between the rotor 40 and the stator 20. One end of the shaft 42 securely couples to the hub 41 and the other end of the shaft 42 as a free end rotatably extends through the central hole 33 of the bearing 30. Furthermore, an annular groove 421 is formed in an outer periphery of the shaft 42 and close to the free end of the shaft 42 to form a neck of the shaft 42. As shown in FIG. 4, the neck has a first outer diameter “D1” and the shaft 42 further has an obstructing portion 422 that forms an end edge of the annular groove 421 and close to the free end of the shaft 42, with the annular groove 421 being between the obstructing portion 422 and the hub 41. Besides, the obstructing portion 422 has a second outer diameter “D2” larger than the first outer diameter “D1”.

The retaining ring 50 is received in the shaft tube 11 of the base 10 and partially received in the annular groove 421 of the shaft 42. The retaining ring 50 includes a combining section 51 and a retaining section 52. The retaining ring 50 abuts against the second end face 32 by the combining section 51, so as to be assuredly located at a predetermined position inside the shaft tube 11 without any movement. Referring again to FIG. 4, the combining section 51 has an outer lateral edge 511 and two end faces those are a first positioning face 512 facing the hub 41 and a second positioning face 513, wherein the outer lateral edge 511 radially abuts on an inner surface of the shaft tube 11 and thus the retaining ring 50 is securely positioned in the shaft tube 11 without radial movement. Moreover, the first positioning face 512 abuts on the second end face 32 of the bearing 30 to position the retaining ring 50 without axial movement, with the first end face 31 of the bearing 30 facing the hub 41. Optionally, the second positioning face 513 can abut on the end cap 12 while the end cap 12 forms the second end 112 of the shaft tube 11, so that the retaining ring 50 can be sandwiched between the bearing 30 and the end cap 12 to provide a more reliable combination of the retaining ring 50 and the shaft tube 11.

Still referring to FIG. 4, the retaining section 52 of the retaining ring 50 delimits a through hole 53 by a blocking edge 521 of the retaining section 52, with the blocking edge 521 radially extending towards a central line of the through hole 53 to be within a longitudinal extending area of the central hole 33 of the bearing 30. Additionally, the blocking edge 521 is able to flexibly deform to expand the through hole 53 while an external force is applied to the retaining ring 50, so that the obstructing portion 422 of the shaft 42 can be forcibly inserted through the through hole 53 of the retaining ring 50 easily. Besides, a diameter “d” of the through hole 53 is larger than the first outer diameter “D1”, so that a gap “G” is formed between a periphery of the through hole 53 and the neck formed by the annular groove 421, with the gap “G” having a width, which is a distance from the periphery of the through hole 53 to a bottom surface of the neck, of 0.67 mm or smaller than 0.67 mm. Preferably, the width of the gap “G” is equal to or smaller than 0.37 mm. The diameter “d” of the through hole 53 is also smaller than the second outer diameter “D2”, and thus the retaining section 52 of the retaining ring 50 is assured to retain the obstructing portion 422 of the shaft 42 to avoid departure of the rotor 40 from the base 10.

Moreover, referring again to FIG. 4, the free end of the shaft 42 preferably forms a curve-shaped extremity 423 adjoining the obstructing portion 422, so that the obstructing portion 422 can pass through the through hole 53 of the retaining ring 50 smoothly due to the deformation of the blocking edge 521 caused by forcible passage of the curve-shaped extremity 423 through the through hole 53. On the other hand, an end of the obstructing portion 422, which forms the end edge of the annular groove 421, is preferably an annular plane 424 parallel to the retaining section 52 of the retaining ring 50. Hence, after the obstructing portion 422 goes through the retaining ring 50 and the blocking edge 521 returns to its original state without deformation, a great difficulty in pulling the shaft 42 out of the retaining ring 50 is provided, and reliable departure-proof effect on the rotor 40 is thus achieved.

In assembly of the motor 1 of the first embodiment, the stator 20 is mounted on the base 10 while the retaining ring 50 and the bearing 30 are mounted into the shaft tube 11 of the base 10, with the retaining ring 50 being arranged between the bearing 30 and the end cap 12 of the shaft tube 11, and the through hole 53 aligning with the central hole 33 of the bearing 30. By the design of the combining section 51, the retaining ring 50 is certainly positioned in the shaft tube 11 without moving after the bearing 30 and the retaining ring 50 are mounted into the shaft tube 11. After passage of the shaft 42 of the rotor 40 through the central hole 33 of the bearing 30, the obstructing portion 422 of the shaft 42 can smoothly and easily go through the through hole 53 of the retaining ring 50, with the retaining ring 50 surrounding the annular groove 421 of the shaft 42 to finish the assembly of the motor 1. Alternatively, the retaining ring 50 is mounted around the annular groove 421 after the shaft 42 of the rotor 40 passes through the central hole 33 of the bearing 30, and then the end cap 12 is fastened to the second end 112 of the shaft tube 11. Obviously, limits in sequence of steps in assembling the motor 1 of the present invention are reduced, and thus it is easy to assemble the motor 1.

As has been discussed above, the motor 1 indeed has many advantages as the following.

First, revolving stability is enhanced. Because there is the gap “G” between the periphery of the through hole 53 of the retaining ring 50 and the neck of the shaft 42, the retaining ring 50 absolutely not rotates with the shaft 42 to improve revolving stability of the rotor 40 effectively. Also, friction-induced noise is suppressed effectively because the retaining ring 50 seldom touches the shaft 42 during rotation of the rotor 40 driven by the stator 20.

Second, a simplified structure is provided. The retaining ring 50 can be fixedly positioned in the shaft tube 11 without any movement by the configuration of the combining section 51. And by the blocking edge 521 being within the longitudinal extending area of the central hole 33 of the bearing 30, the retaining ring 50 is able to retain the shaft 42 while the retaining section 52 touches the annular plane 424 of the obstructing portion 422 of the shaft 42, so that departure of the rotor 40 from the base 10 is avoided during packing, loading and unloading, conveyance or operation of the motor 1. Accordingly, the oil seal, washer and gasket of the conventional motor 9 are dispensable to reduce structural complexity of the motor 1 of the present invention.

Third, convenience of assembling is provided. Owing to the simplified structure of the motor 1, the retaining ring 50 can be securely positioned in the shaft tube 11 by the combining section 51 after the retaining ring 50 and the bearing 30 are disposed in the shaft tube 11, with the through hole 53 of the retaining ring 50 and the central hole 33 of the bearing 30 aligning with each other. Accordingly, the rotor 40 can be quickly coupled to the base 10 to enhance convenience of assembling.

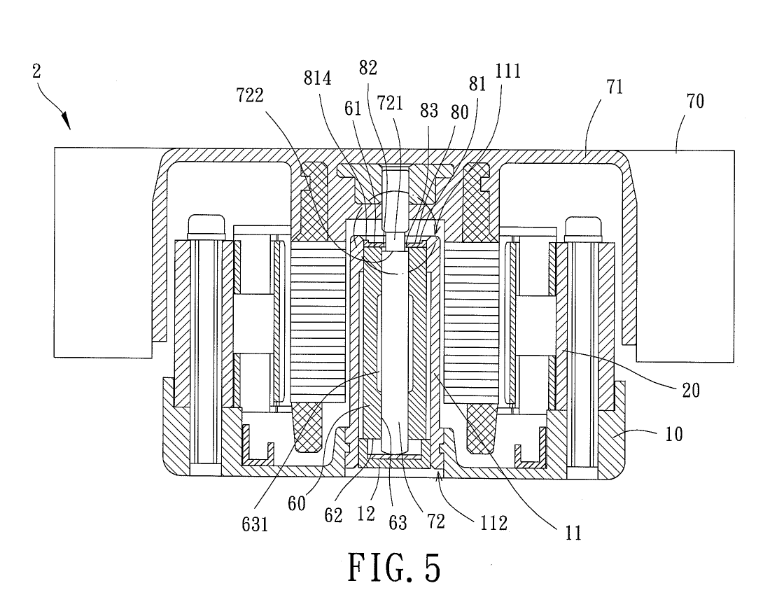

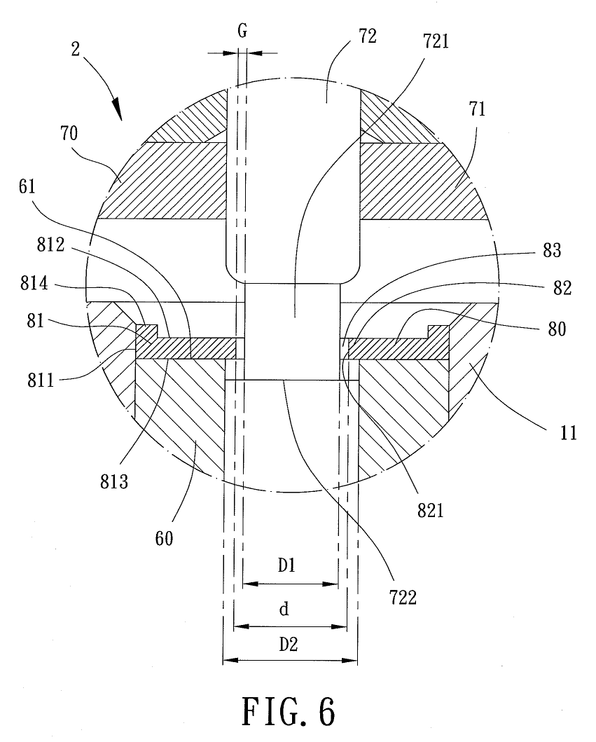

FIGS. 5 and 6 show a motor 2 of a second embodiment according to the preferred teachings of the present invention. In the preferred form shown, the motor 2 includes a base 10, a stator 20, a bearing 60, a rotor 70 and a retaining ring 80, wherein the base 10 and stator 20 are similar to those of the first embodiment and descriptions of the similarities are therefore omitted.

The bearing 60 has a first end face 61, a second end face 62 and a central hole 63 connecting with the first end face 61 and the second end face 62. The major difference between the first embodiment and the second embodiment is shown as the following. A diameter of a part of the central hole 63 of the bearing 60 is larger than those of the other parts of the central hole 63 to form an oil-storing compartment 631 inside the bearing 60 for receiving lubricant, and thus the rotor 70 is able to revolve more smoothly. Besides, the second end face 62 of the bearing 60 abuts on the end cap 12. The rotor 70 of the second embodiment includes a hub 71 and a shaft 72 having an annular groove 721, and the major difference between the rotor 70 and the rotor 40 of the first embodiment is locations of the annular grooves 421, 721. Specifically, the annular groove 721 of the shaft 72 is formed in an outer periphery thereof and close to an end of the shaft 72 securely coupling to the hub 71, namely, the end of the shaft 72 not extending through the central hole 63, to form a neck of the shaft 72, as shown in FIG. 6. Furthermore, the neck of the shaft 72 has a first outer diameter “D1” and the shaft 72 further has an obstructing portion 722 that forms an end edge of the annular groove 721, with the annular groove 721 being between the obstructing portion 722 and the hub 71. The obstructing portion 722 has a second outer diameter “D2” larger than the first outer diameter “D1”.

The retaining ring 80 of the second embodiment includes a combining section 81, an outer lateral edge 811, a first positioning face 812, a second positioning face 813, a retaining section 82, a blocking edge 821 and a through hole 83 and the major difference between the retaining ring 80 and the retaining ring 50 of the first embodiment is shown as the following. Referring again to FIG. 6, the second positioning face 813 of the combining section 81 abuts and is fixed on the first end face 61 of the bearing 60 and the outer lateral edge 811 radially abuts on the inner surface of the shaft tube 11. Additionally, a positioning flange 814 may be provided on the first positioning face 812, wherein the positioning flange 814 can be integrally formed on the retaining ring 80 or fastened to the retaining ring 80 with the positioning flange 814 and the retaining ring 80 being separately made. A lateral wall of the positioning flange 814 is fixed to the inner surface of the shaft tube 11 to ensure that the retaining ring 80 will never move axially and radially in the shaft tube 11. Therefore, the retaining ring 80 disengaging from the shaft tube 11 is avoided effectively.

Still referring to FIG. 6, the blocking edge 821 extends radially to be within a longitudinal extending area of the central hole 63 of the bearing 60. The blocking edge 821 can further extend radially and inwards to define the through hole 83 smaller than the central hole 63 except for the oil-storing compartment 631. Besides, a diameter “d” of the through hole 83 is larger than the first outer diameter “D1” and smaller than the second outer diameter “D2” to form a gap “G” between the periphery of the through hole 83 and the neck formed by the annular groove 721. Therefore, with the structural features discussed above, the motor 2 of the second embodiment also has the advantages of the motor 1.

In assembly of the motor 2 of the second embodiment, the bearing 60 and the retaining ring 80 are disposed into the shaft tube 11 of the base 10 in sequence. After alignment of the through hole 83 of the retaining ring 80 and the central hole 63 of the bearing 60, the positioning flange 814 is fixed to the inner surface of the shaft tube 11 by adhesive, welding, screwing, close-fit or other methods to fixedly position the retaining ring 80. And then the shaft 72 of the rotor 70 can sequentially pass through the through hole 83 of the retaining ring 80 and the central hole 63 of the bearing 60 easily to complete the motor 2. It is noted that steps in assembling the motor 1 of the first embodiment and motor 2 of the second embodiment are quite different, and it is easier to align the through hole 83 of the retaining ring 80 with the central hole 63 of the bearing 60 due to the retaining ring 80 close to the first end 111 of the shaft tube 11. Therefore, convenience of assembling the motor 2 is further enhanced.

As has been discussed above, during operation of the motor 1, 2 of the present invention, the retaining ring 50, 80 and the shaft 42, 72 are prevented from rubbing against each other to minimize friction-induced noise, and the rotor 40, 70 is assured to not separate from the base 10. Besides, overall structure of the motor 1, 2 is simplified and convenience of assembling is improved to enhance product quality of the motor 1, 2.

Thus since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

What is claimed is:

1. A motor comprising:
a base including a shaft tube;
a stator mounted to the base;
a bearing received in the shaft tube and including a central hole;
a rotor including a shaft rotatably extending through the central hole of the bearing, with an annular groove being formed in an outer periphery of the shaft to form a neck with a first outer diameter, with the shaft including an obstructing portion that forms an end edge of the annular groove and has a second outer diameter larger than the first outer diameter; and
a retaining ring being received in the shaft tube, partially received in the annular groove, and including a combining section positioned at an end face of the bearing and a retaining section with a blocking edge delimiting a through hole, with the blocking edge radially extending towards a central line of the through hole to be within a longitudinal extending area of the central hole of the bearing, with a diameter of the through hole being larger than the first outer diameter to form a gap between a periphery of the through hole and the neck, with the diameter of the through hole being smaller than the second outer diameter to retain the obstructing portion of the shaft of the rotor.

2. The motor as defined in claim 1, wherein the rotor further includes a hub and one end of the shaft couples to the hub, the bearing includes a first end face facing the hub and a second end face, the annular groove is close to another end of the shaft as a free end that rotatably extends through the central hole of the bearing, the combining section includes two end faces those are a first positioning face facing the hub and a second positioning face, and the first positioning face abuts on and is positioned at the second end face of the bearing.

3. The motor as defined in claim 2, wherein the shaft tube includes a first end and a second end, with an end cap being mounted to the second end, with the second positioning face of the combining section of the retaining ring abutting on and being positioned at the end cap to sandwich the retaining ring between the bearing and the end cap.

4. The motor as defined in claim 1, wherein the rotor further includes a hub and one end of the shaft couples to the hub, with the bearing including a first end face facing the hub and a second end face, with the annular groove being close to the hub, with the combining section including two end faces those are a first positioning face facing the hub and a second positioning face, with the first positioning face abutting on and being positioned at the first end face of the bearing.

5. The motor as defined in claim 4, wherein a positioning flange is mounted on the first positioning face of the combining section of the retaining ring, with the positioning flange being fixed to an inner surface of the shaft tube.

6. The motor as defined in claim 1, wherein the combining section of the retaining ring has an outer lateral edge radially abutting on and positioned at an inner surface of the shaft tube.

7. The motor as defined in claim 1, wherein an end of the obstructing portion, which forms the end edge of the annular groove, is an annular plane parallel to the retaining section of the retaining ring.

8. The motor as defined in claim 1, wherein a diameter of a part of the central hole of the bearing is enlarged to form an oil-storing compartment inside the bearing, with the blocking edge extending inwards to define the through hole of the retaining ring smaller than the central hole of the bearing except for the oil-storing compartment.

9. The motor as defined in claim 1, wherein the gap has a width smaller than or equal to 0.67 mm, with the width being a distance from the periphery of the through hole to a bottom surface of the neck.
